(19) United States
(12) Patent Application Publication
(10) Pub. No.: US 2026/0189506 A1
(43) Pub. Date: Jul. 2, 2026

(54) LOW LATENCY, LOW LOSS, SCALABLE THROUGHPUT FOR NON-SUPPORTED DEVICES

(71) Applicant: T-MOBILE INNOVATIONS LLC, Overland Park, KS (US)

(72) Inventor: Timur KOCHIEV, Irvine, CA (US)

(21) Appl. No.: 19/007,737

(22) Filed: Jan. 2, 2025

(51) Int. Cl. H04L 47/11; H04L 47/12; H04L 47/25

(52) U.S. Cl. CPC H04L 47/11; H04L 47/12; H04L 47/25

(57) ABSTRACT

Systems and methods are provided for controlling network congestion. A processor of UE is configured by machine-readable instructions to communicate data packets between the UE and a wireless network that further communicates with an additional UE. The UE is low latency, low loss, scalable throughput (L4S) enabled and the additional UE is not L4S enabled. The UE that is L4S enabled receives a first notification of wireless network congestion for the wireless network and sends a second notification to the additional UE of the wireless network congestion by the UE. The second notification causes the additional UE that is not L4S enabled to mitigate the wireless network congestion.

### TECHNICAL BACKGROUND

A wireless network, such as a cellular network, can include an access node (e.g., wireless access node) serving multiple wireless devices or user equipment (UE) in a geographical area covered by a radio frequency transmission provided by the access node. Access nodes may deploy different carriers within the cellular network utilizing different types of radio access technologies (RATs). RATs can include, for example, 3G RATs (e.g., GSM, CDMA etc.), 4G RATs (e.g., WiMax, LTE, etc.), and 5G RATs (new radio (NR)).

Further, different types of access nodes may be implemented for deployment for the various RATs. For example, a next generation NodeB (gNodeB or gNB) may be utilized for 5G RATs. Deployment of the evolving RATs in a network provides numerous benefits. For example, newer RATs may provide additional resources to subscribers, faster communications speeds, and other advantages.

Although 5G RATs boost network capacity and communication speeds, the 5G RATs can become congested and experience packet loss as applications require more bandwidth and speed for communicating data. Low Latency, Low Loss, Scalable Throughput (L4S) technology is used to improve the performance of the 5G RATs by reducing latency, minimizing packet loss, and maintaining high throughput, especially in congested networks. L4S is designed to enhance the responsiveness of real-time applications like video conferencing, online gaming, and virtual reality, while also benefiting cloud services and other data-intensive tasks

### OVERVIEW

One aspect of the present disclosure relates to a system configured for congestion control in a wireless network. UE may include one or more hardware processors configured by machine-readable instructions. The processor(s) of UE may be configured to communicate data packets between the UE and a wireless network that further communicates with an additional UE. The UE may be L4S enabled and the additional UE may be L4S non-enabled. The UE that is L4S enabled may further be configured to receive a first notification of wireless network congestion for the wireless network and send a second notification to the additional UE of the wireless network congestion by the UE. The second notification may then cause the additional UE that is not L4S enabled to mitigate the wireless network congestion.

In some implementations of the system, the first notification of wireless network congestion to the UE indicates a congestion control threshold has been satisfied for the wireless network. In certain implementations of the system, a mechanism for the notification of the wireless network congestion is Explicit Congestion Notification (ECN). A mechanism for notifying the second UE of the wireless network congestion by the first UE may be one or more of the following: radio access network (RAN), Bluetooth and Wi-Fi.

Additionally, the mitigation of the wireless network congestion by the second UE may comprise one or more of the following: decreasing application data rate of the data packets sent by the second UE and delaying non-critical data transfer by the second UE. The decreasing of the application data rate of the data packets may comprise modifying usage of an application used by the second UE. Further, the decreasing of the application data rate of the data packets to the second UE may comprise reducing a data rate.

In one implementation, the decreasing of the application data rate of the data packets sent to the second UE may comprise using an artificial intelligence (AI) machine learning (ML) model to decrease the application data rate based on historical congestion information shared by the first UE. The mitigation of the wireless network congestion by the second UE may comprise selecting other possible network paths and/or improving performance of the second UE.

Another aspect of the present disclosure relates to a method for congestion control in a wireless network. The method may include communicating data packets between a wireless network, a first user equipment (UE), and a second UE, wherein the first UE is L4S enabled and the second UE is not L4S enabled; and sending, by the wireless network, a first notification of wireless network congestion of the wireless network to the first UE that is L4S enabled, wherein the first notification triggers the first UE to send a second notification of network congestion to the second UE that is not L4S enabled, and wherein the second notification causes the second UE to mitigate the wireless network congestion.

Yet another aspect of the present disclosure relates to a non-transitory computer-readable storage medium having instructions embodied thereon, the instructions being executable by one or more processors to perform steps for congestion control in a wireless network. The steps may include: communicating data packets between the UE and a wireless network that further communicates with an additional UE, wherein the additional UE is L4S enabled and the UE is not L4S enabled; and receiving, by the UE that is not L4S enabled, a notification of wireless network congestion for the wireless network that causes the UE to mitigate the wireless network congestion, wherein the notification is sent to the UE by the additional UE that is L4S enabled in response to the additional UE receiving an additional notification from the wireless network of the wireless network congestion.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a,’ ‘an,’ and ‘the’ include plural referents unless the context clearly dictates otherwise.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more examples of the present teachings and together with the description explain certain principles and operations. In the drawings:

FIG. 1 illustrates an exemplary system for wireless communication in accordance with various aspects of the present disclosure.

FIG. 2 illustrates a congestion control system, in accordance with an embodiment.

FIG. 3 illustrates a method for configuring a wireless network, in accordance with an embodiment.

FIG. 4 illustrates an IP Header, in accordance with an embodiment.

FIG. 5 illustrates an exemplary method for providing network congestion control for L4S non-supported devices in accordance with various aspects of the present disclosure.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In addition to the particular systems and methods described herein, the operations described herein may be implemented as computer-readable instructions or methods, and a processor on the network for executing the instructions or methods. The processor may include an electronic processor.

Existing wireless networks can become overloaded with data packets causing queueing, delay, and packet drop which negatively affect network performance. Current network configurations allow more traffic to enter the wireless network than the network can handle. In a wireless network, a 5G gNB can be a bottleneck in terms of latency and capacity.

To improve utilization of 5G resources, as an example, multiple congestion control algorithms may be used for the same application. For example, the network may be configured in the wireless network to communicate data packets between the same application and user equipment (UE). Using configuration profiles, the network is configured for different data packet types for communication between the same application and the UE. The network profile may be configured using L4S, which improves network latency and packet loss by applying optimized congestion control (CC) algorithms for time critical applications.

When the network is configured for the same application using L4S, network RANs may be used for different data packet types and different congestion control algorithms may be applied to different data packet types. A L4S network profile may be configured in the wireless network for different data packet types. Exemplary RANs may include new radio access networks such as 5G ultra-reliable low-latency communication (URLLC), 5G enhanced mobile broadband (eMBB), and 5G massive machine-type communications (MTTC). It is costly to deploy some 5G radio access network (RAN), such as 5G URLLC, features all over the wireless network. As such, it is beneficial to separate critical content data packet types from less critical content data packet types.

An L4S profile allows a URLLC edge network to be utilized for the critical part of the extended reality (XR) content and the less costly eMBB network for less critical XR content. The network for 5G eMBB may be configured for less critical predicted/bi-directional frames of XR content. An L4S profile also allows different congestion control algorithms to be applied to different data packet types to reach the best XR resource utilization, saving deployment cost for mobile network operators (MNO).

While L4S improves performance, widespread support of L4S is not common and only some devices support L4S. Therefore, in the existing technology, the devices that do not support L4S have a degraded user experience during congestion and there is a need to improve performance for the non-L4S supported devices when congestion occurs.

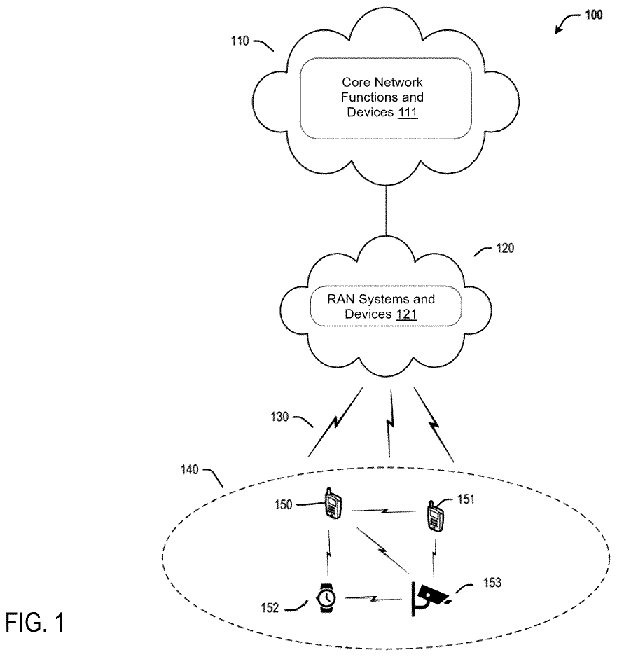

FIG. 1 depicts an exemplary system 100 for wireless communication, in accordance with the disclosed embodiments. The system 100 may include a core network 110, a radio access network (RAN) 120 and multiple wireless devices 150-153 able to communicate within each other. The wireless devices 150-153 may be end-user wireless devices and may be connected to operate within a local network 140 that communicates with the RAN 120 over communication links 130, which may for example be 5G NR communication links, 4G LTE communication links, or any other suitable type of communication link. The local network 140 may be a home internet network, or devices 150-153 may be connected to the same mesh WiFi, for example.

In one implementation, some of the wireless devices 150-153 are L4S enabled and the remaining wireless devices 150-153 are not L4S enabled. Further, the wireless devices 150-153 may be capable of communicating with each other by sharing information such as network conditions, e.g., network congestion, overall network data packet bit rate, bit rates of data packets received by individual devices, etc. In addition, the wireless devices 150-153 may share information regarding which devices are L4S enabled and which devices are not L4S enabled. In one example, devices 150-151 are L4S enabled, and devices 152-153 are L4S non-enabled. Additionally, the wireless devices 150-153 can share the data packets with each other upon request and approval.

The core network 110 includes core network functions and devices 111. The core network may be structured using a service-based architecture (SBA). One of the core network functions may be to mark the data packets sent to the local network 140. In one implementation, an artificial intelligence (AI) machine learning (ML) model, included in the core network functions 111, is trained to instruct the devices 152-153 to adjust/modify data packets bit rates. The data adjustment/modification may be performed based on the network congestion. The AI ML model may be trained to instruct devices 152-153 to adjust/modify data packets bit rates.

The RAN 120 may include various RAN systems and devices 121. The RAN systems and devices 121 are disposed between the core network 110 and the end-user wireless devices 150-153. Some of the RAN systems and devices 121 may communicate directly with the core network 110 and others may communicate directly with the end user wireless devices 150-153. Other RAN systems and devices 121 may communicate with one another within the RAN in order to provide services from the core network 110 to the end-user wireless devices 150-153. The wireless devices 150-153 may communicate with each other directly, or via the RAN. In addition, the wireless devices 150-153 may communicate with each other vie Bluetooth, Wi-Fi, or any other means of communication deemed suitable.

The RAN 120 includes at least an access node (or base station), such as an eNodeB, a next generation NodeB (gNodeB) communicating with a plurality of end-user wireless devices. It is understood that the disclosed technology may also be applied to communication between an end-user wireless device and other network resources, such as relay nodes, controller nodes, antennas, etc. Further, multiple access nodes may be utilized. For example, some wireless devices 150-153 may communicate with an LTE eNodeB and others may communicate with an NR gNodeB.

Access nodes can be, for example, standard access nodes such as a macro-cell access node, a base transceiver station, a radio base station, an eNodeB device, an enhanced eNodeB device, a next generation NodeB (or gNodeB) in 5G New Radio (“5G NR”), or the like. In additional embodiments, access nodes may comprise two co-located cells, or antenna/transceiver combinations that are mounted on the same structure. Alternatively, access nodes may comprise a short range, low power, small-cell access node such as a microcell access node, a picocell access node, a femtocell access node, or a home eNodeB device.

Access nodes can be configured to deploy at least two different carriers, each of which utilizes a different RAT. For example, a first carrier may be deployed by an access node in an LTE mode, and a second carrier may be deployed by an access node in an NR mode. Thus, in an embodiment, the access node may comprise two co-located cells, or antenna/transceiver combinations that are mounted on the same structure. In some embodiments, multiple access nodes may be deployed, and each access node may support a different RAT. For example, a gNodeB may support NR and an eNodeB may provide LTE coverage. Any other combination of access nodes and carriers deployed therefrom may be evident to those having ordinary skill in the art in light of this disclosure.

The access nodes can comprise a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

Each of wireless devices 150-153 may be capable of simultaneously communicating with the RAN 120 using combinations of antennae via 4G and 5G or any other RAT or transmission mode, including multiple carriers. For instance, MU-MIMO pairings and SU-MIMO pairings can be made by wireless devices 150-153. It is noted that any number of access nodes, antennae, MU-MIMO pools, carriers, and wireless devices can be implemented.

Wireless devices 150-153 may be any device, system, combination of devices, or other such communication platform capable of communicating on the wireless network using one or more frequency bands deployed therefrom. Wireless devices 150-153 may be divided into two categories for the purposes of this disclosure: L4S supported devices and L4S non-supported devices. Wireless devices 150-153 may be eMBB devices and may be, for example, mobile phones, wireless phones, cellular home internet modems, personal digital assistants (PDA), tablet computers, as well as other types of devices or systems that can exchange audio or data via the wireless network as non-reduced capability devices. Further, wireless devices 150-153 may be reduced capability (RedCap) devices and may include smart watches and other wearables, industrial sensors, and video surveillance equipment, for example. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). System 100 may be capable of communicating signals and carrying data, for example, to support voice, push-to-talk, broadcast video, and data communications by end-user wireless devices 150-153. Wireless network protocols may include one or more of Multimedia Broadcast Multicast Services (MBMS), code division multiple access (CDMA) 1×RTT (radio transmission technology), Global System for Mobile communications (GSM), Universal Mobile Telecommunications System (UMTS), High-Speed Packet Access (HSPA), Evolution Data Optimized (EV-DO), Worldwide Interoperability for Microwave Access (WiMAX), Third Generation Partnership Project Long Term Evolution (3GPP LTE), Fourth Generation broadband cellular (4G, LTE Advanced, etc.), and Fifth Generation mobile networks or wireless systems (5G, 5G New Radio (“5G NR”), or 5G LTE). Wired network protocols utilized by communication network 101 may include one or more of Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. the core network functions and devices 111 and RAN 120.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication system 100 may be, comprise, or include computers systems and/or processing nodes. This includes, but is not limited to other core network functions and devices 111, and RAN systems and devices 121.

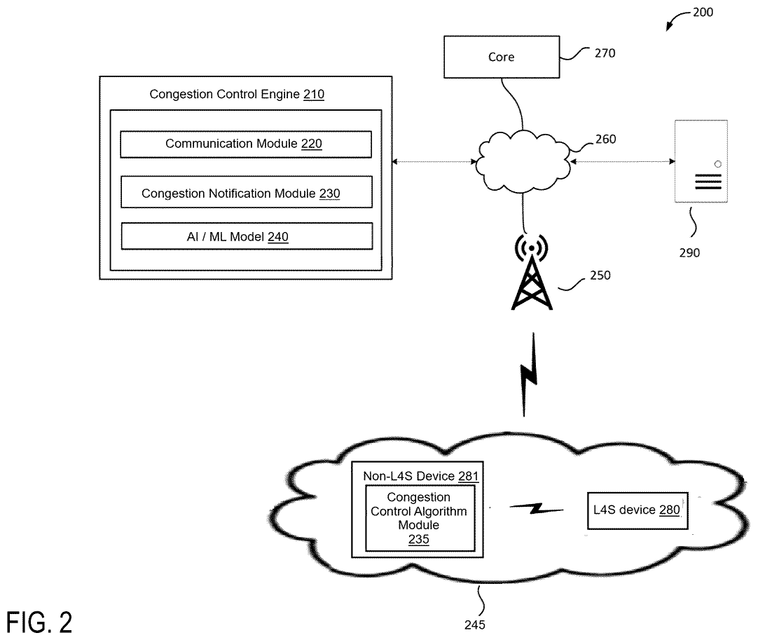

FIG. 2 illustrates a system 200 configured for routing data packets, in accordance with one or more implementations. As illustrated, system 200 comprises congestion control engine 210, an access node 250, a network 260, a core 270, which provide service in a coverage area, a host application server 290, and a local network 245. L4S supported UE (L4S_UE) 280, an L4S non-supported UE (nL4S_UE) 281 may be end-user wireless devices and may be connected to operate within the local network 245 that communicates with RAN over communication links, which may for example be 5G NR communication links, 4G LTE communication links, or any other suitable type of communication link. The local network 245 may be a home internet network, or L4S_UE 280 and nL4S_UE 281 may be connected to the same mesh WiFi, for example. In one implementation, nL4S_UE 281 includes congestion control algorithm module 235, which will be explained further in detail. For purposes of illustration and ease of explanation, only one access node 250, L4S_UE 280, nL4S_UE 281 and host application server 290 are shown in the system 200; however, additional access nodes and/or application host servers and UEs may be present in the system 200.

In the illustration of FIG. 2, the access node 250 is connected to the network 260 via an NR path (including the 5G core 270). In practical implementations, the access node 250 may be connected to network 260 via multiple paths (e.g., using multiple RATs and/or wired backhaul links). The access node 250 may connect to the network core 270 via wired connections, e.g., fiber, broadband, T1, and microwave relays may be used as well. The access node 250 may communicate with the core 270 via one or more communication links, each of which may be a direct link. However, it will be appreciated that network 260 may be any type of network facilitating communication among congestion control engine 210, access node 250, host application server 290, core 270, and local network 245, where L4S_UE 280, and nL4S_UE 281 reside.

The access node 250 may be any network node configured to provide communications between the connected wireless devices. As examples of a standard access node, the access node 250 may be a gNodeB in 5G networks. Access node 250 and core 270 may also provide data to congestion control engine 210. The congestion control engine 210 is in communication with the access node 250 and/or the core 270. The congestion control engine 210 may be configured for routing data packets from an application.

The congestion control engine 210 can comprise one or more electronic processors and associated circuitry to execute or direct the execution of computer-readable instructions such as those described herein. In so doing, the congestion control engine 210 can retrieve and execute software from storage, which can include a disk drive, a flash drive, memory circuitry, or some other memory device, and which may be local or remotely accessible. The software may comprise computer programs, firmware, or some other form of machine-readable instructions, and may include an operating system, utilities, drivers, network interfaces, applications, or some other type of software, including combinations thereof.

As illustrated the congestion control engine 210 utilizes a modular controller, a memory, wireless communication circuitry, and a bus through which the various elements of the congestion control engine 210 may communicate with access node 250, core 270, L4S_UE 280, nL4S_UE 281, and host application server 290. The modular controller is one example of an electronic processor, and may include sub-modules or units, each of which may be implemented via dedicated hardware (e.g., circuitry), software modules which are loaded from the memory and processed by the controller, firmware, and the like, or combinations thereof.

While FIG. 2 illustrates communication module 220, congestion notification module 230, as being separate modules, in practical implementations some of the modules may be combined with one another and/or may share components. The communication module 220, congestion notification module 230, may be configured to perform various operations to implement methods in accordance with the present disclosure. While one example of operations performed by the modules is described here, in practical implementations at least some of the operations described as being performed by one module may instead be performed by another module, including a module not explicitly named here.

L4S may be an over-the-top method for rate adaptation between a L4S_UE 280 and a host application server 290. L4S may have a large buffer to have enough time to react to changes in network conditions L4S enables low latency, high-rate communications with dynamic rate adaptation, even when the wireless network is loaded. L4S provides real-time dynamic rate adaptation algorithms at the application layer. L4S utilizes ECN (Explicit Congestion Notification), Dual Queue Coupled Active Queue Management (AQM), and scalable congestion control algorithms to reduce latency and packet loss. The congestion control algorithms may be optimized for the wireless network.

After the 5G network is configured, communication module 220 communicates data packet types between L4S_UE 280 as well as nL4S_UE 281, and host application server 290 using a wireless network for a RAN. The application may be an extended reality or gaming application. Congestion notification module 230 may be configured to receive a notification of wireless network congestion for the wireless network. The notification of wireless network congestion may indicate a congestion control threshold has been satisfied for the data packet types.

In one implementation, upon the occurrence of network congestion, the notification module 230 informs L4S_UE 280 of the congestion, and L4S_UE 280 activates the L4S capability. At the same time, nL4S_UE 281 is detected on the network as not being L4S supported. As a result, congestion control engine 210 instructs L4S_UE 280 to notify nL4S_UE 281 of the congestion on the network. L4S_UE 280 may notify nL4S_UE 281 of the wireless congestion via radio access network (RAN), or Bluetooth, or Wi-Fi, or in any other way considered appropriate.

In response to the notification, nL4S_UE 281 mitigates the congestion by activating congestion control algorithm module 235. In one implementation, congestion control algorithm module 235 of nL4S_UE 281 decreases the application data rate of the data packets from nL4S_UE 281. In another implementation, congestion control algorithm module 235 instructs nL4S_UE 218 to delay non-critical data transfer. In yet another implementation, congestion control algorithm module 235 instructs nL4S_UE 218 to select alternative network paths. Further, nL4S_UE 281 may decrease the application data rate of the data packets by modifying usage and data consumption of the applications used by the device for non-critical applications.

Lowering the data transfer bit rate by selecting alternative network paths may involve traffic engineering or network optimization. Further, congestion control algorithm module 235 may be used to choose alternative backhaul links, radio links, different network slices, and/or different network gateway options. In one implementation, path selection may be performed based on bandwidth and latency. Different network paths may have varying capacities, delays, and congestion levels. Selecting a path with higher latency or limited bandwidth may lower the feasible rate for data transfer. For example, a high-speed path may be direct, low-latency, and less congested, supporting higher bit rates, while an alternative path may have longer route with more hops or lower bandwidth, reducing the overall data transfer rate.

In another implementation, selecting alternative network paths may involve routing protocol adjustments. For example, protocols like Multiprotocol Label Switching (MPLS) or Software-Defined Networking (SDN) can dynamically adjust traffic paths to distribute load, potentially selecting paths with lower capacities to intentionally throttle the transfer rate. Modifying routing protocols may include setting routing metrics to prioritize slower paths and/or using dynamic routing algorithms to distribute traffic evenly, avoiding paths that enable high bit rates. In still another implementation, traffic shaping and rate limiting on paths is performed. The network can be administered to configure rate limits on specific network paths by, for example, implementing Quality of Service (QoS) policies, or by applying traffic shaping to limit the maximum transfer rate on selected paths.

In one implementation, congestion control engine 210 includes artificial intelligence (AI) machine learning (ML) model 240 that learns data rate mitigation based on historical congestion information. The AI ML model 240 may be trained using the L4S data of L4S_UE 280. Accordingly, once L4S_UE 280 notifies nL4S_UE 281 device that the network is congested, the AI ML model 240 can be applied on nL4S_UE 281 to adjust/decrease the rate of the data packets sent, delay non-critical data transfer of nL4S_UE 281, and/or to select alternative network paths for nL4S_UE 281.

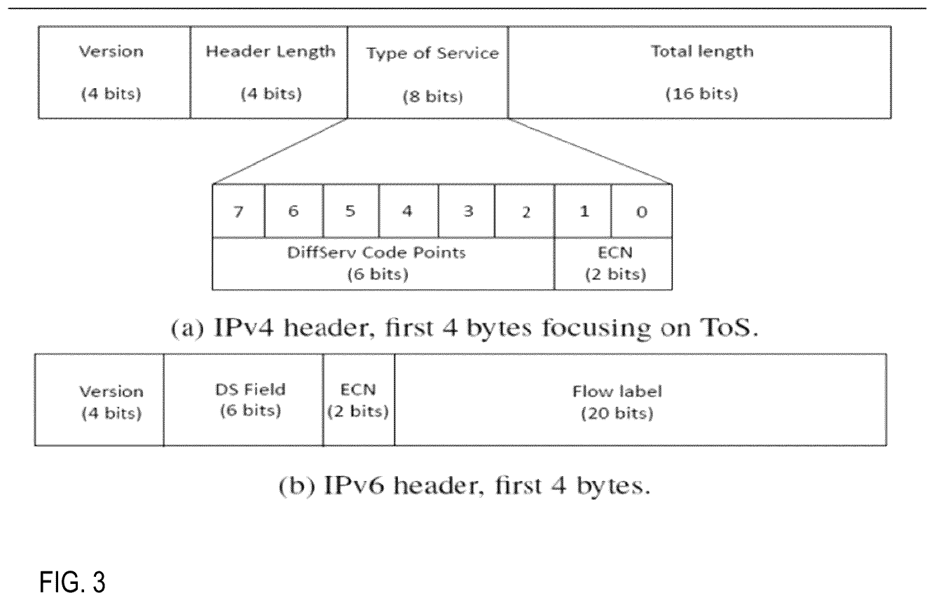

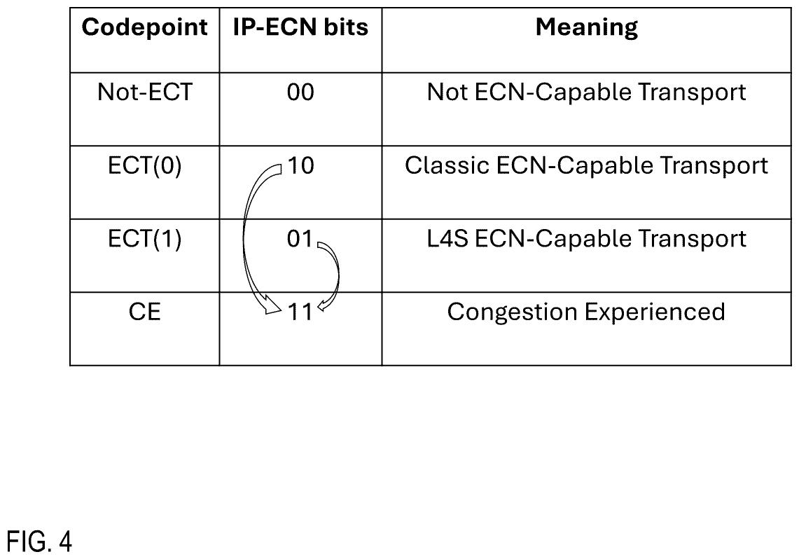

Classic TCP/IP networks signal congestion by dropping packets. ECN aware node sets up a marker in the IP header. A receiver sends a congestion indication to the sender who reduces its transmission rate. However, when using L4S configurations, as shown in FIG. 3 and FIG. 4, the ECT profile allows a host application server to distinguish L4S and classic traffic using an identifier of ECT(1) and Congestion Experienced (CE) codepoints of the ECN field. ECN is defined in RFC3168 (2001) which allows end-to-end (E2E) notification of network congestion without dropping packets.

Applications using L4S can have both low network delays and high throughput. L4S may be used for conversational audio/video applications, interactive applications with dynamic content, interactive video, live streaming, cloud or online gaming, and virtual or augmented reality. In certain end-to-end paths from client to server (or server to client), there may be the slowest link at any moment of time, referred to as the bottleneck. When the sender's rate is higher than the bottleneck link rate, a queue may build up at the bottleneck, leading to increased delays and eventual loss, which informs the sender that the rate needs to slow down.

L4S may use the ECN mechanism to provide early warning of congestion at the bottleneck link by marking a CE codepoint in the IP header of packets. After receiving the packets, the receiver may echo the congestion information to the sender in the acknowledgement (ACK) packets of the transport protocol. The sender may use this congestion feedback to reduce its sending rate to avoid delays at the bottleneck. L4S may further require implementation updates at end devices as well as on the network bottleneck. In certain examples, L4S may be supported for the QUIC and TCP networking stacks.

For example, L4S_UE 280 may indicate that the device is L4S capable by setting the ECN-Capable Transport (ECT) codepoint to 01, shown in FIG. 4, known as ECT(1). To confirm that L4S_UE 280 is L4S capable, the system 200 may look for ECT(1) in the IP header of transmitted packets. Some networks may bleach (zero) the ECN field and perform validation in the beginning of the connection to test for bleaching. If bleaching is detected, the system 200 may not use ECN and, therefore, L4S for such connections.

When L4S is enabled for the TCP receiver side, L4S_UE 280 may negotiate accurate ECN during the three-way handshake with the server, which is used for providing the detailed congestion feedback an L4S sender needs. An ECN protocol may use two ways to provide feedback. TCP header may indicate the number of packets arriving with a CE codepoint in the IP-ECN field. AE, CWR, and ECE (ACE) may be the flags that convey accurate ECN information. Accurate ECN TCP options may provide feedback about the number of bytes arriving with one of the three ECN code points: ECT(1), ECT(0), and CE.

Certain TCP implementations provide both types of feedback. To confirm that an implementation negotiated accurate ECN in the three-way handshake, a packet capture on the device can be taken in search for the synchronize (SYN) packet for the flags set. Then, to check how the server responded to this request, the system 200 may check if TCP flags are set on the synchronize-acknowledge (SYN-ACK) packet.

After the negotiation is complete, the server 290 may send data packets. Being that the server 290 supports L4S sender-side behavior, the server 290 indicates that L4S_UE 280 is L4S capable by setting the ECT codepoint to 01; otherwise, for nL4S_UE 281 for example, ECT codepoint remains 00. The system may check for ECT(1) in the client-side packet capture by looking at packets from the server to the client.

By way of non-limiting example, a congestion control algorithm may be one of Data Center Transmission Control Protocol (DCTCP), Transmission Control Protocol (TCP) Prague, an L4S variant of the RTP Media Congestion Avoidance Techniques (RMCAT) Self-Clocked Rate Adaptation for Multimedia (SCReAM) controller and the L4S ECN part of Bottleneck Bandwidth and Round-trip propagation time version (BBRv2) intended for TCP and Quick UDP Internet Connections (QUIC) Transport.

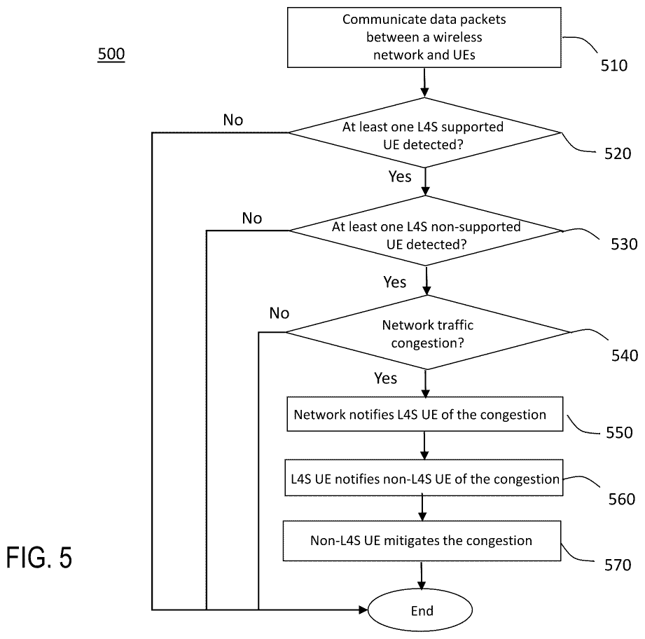

FIG. 5 illustrates an exemplary method 500 for providing network congestion control for L4S non-supported devices. Method 500 starts in step 510, in which data packets are communicated between a wireless network and UEs. In step 520, congestion control engine 210 inquires whether at least one of the UEs is L4S supported. If an L4S device is detected, congestion control engine 210 proceeds to step 530 to inquire whether at least one of the UEs is L4S non-supported.

In instances when at least one L4S and at least one non-L4S device is detected on the network, such devices differ in terms of their potential response to a network congestion. Therefore, in step 540, congestion control engine 210 further inquiries whether network traffic congestion is occurring. In one implementation, engine 210 compares the network traffic with a congestion control threshold, and if the threshold is met for the wireless network, the engine 210 determines that the network is congested.

In step 550, the network notifies the L4S supported device of the congestion and the L4S device activates the L4S feature. In one example, a mechanism for notifying the L4S supported device of wireless network congestion is ECN. A receiver sends a congestion indication to the L4S supported device that reduces its transmission rate. However, when using L4S configurations, the ECT profile allows a host application server to distinguish L4S and classic traffic using an identifier of ECT(1) and CE codepoints of the ECN field. ECN then allows end-to-end (E2E) notification of network congestion without dropping packets.

In certain instances, activation of the L4S feature addresses the traffic congestion for the L4S supported device, but not for the L4S non-supported device. Therefore, in step 560, the L4S supported device provides notification to the L4S non-supported UE that the network traffic is congested. In one implementation, a mechanism for notifying the L4S non-supported device of the wireless network congestion is RAN, Bluetooth and/or Wi-Fi.

In response to receiving the notification, in step 570, the L4S non-supported UE mitigates the network congestion. The mitigation techniques may include decreasing application data rate of the data packets of the L4S non-supported UE, delaying non-critical data transfer from the L4S non-supported UE, and/or selecting alternative network paths for the L4S non-supported device. The mitigation techniques may further include modifying usage of an application used by the L4S non-supported UE and/or reducing a data rate by the wireless network.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

All terms used in the claims are intended to be given their broadest reasonable constructions and their ordinary meanings as understood by those knowledgeable in the technologies described herein unless an explicit indication to the contrary is made herein. In particular, the use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A user equipment (UE) comprising:
one or more hardware processors configured by machine-readable instructions to:
communicate data packets between the UE and a wireless network that further communicates with an additional UE, wherein the UE is low latency, low loss, scalable throughput (L4S) enabled and the additional UE is not L4S enabled;
receive, by the UE that is L4S enabled, a first notification of wireless network congestion for the wireless network; and
send a second notification to the additional UE of the wireless network congestion by the UE,
wherein the second notification causes the additional UE that is not L4S enabled to mitigate the wireless network congestion.

2. The user equipment of claim 1, wherein the first notification of wireless network congestion to the UE indicates a congestion control threshold has been satisfied for the wireless network.

3. The user equipment of claim 1, wherein a mechanism for notifying the UE of the wireless network congestion is Explicit Congestion Notification (ECN).

4. The user equipment of claim 1, wherein a mechanism for notifying the additional UE of the wireless network congestion by the UE is one or more of the following: radio access network (RAN), Bluetooth and Wi-Fi.

5. The user equipment of claim 1, wherein mitigation of the wireless network congestion by the additional UE comprises one or more of the following:
decreasing application data rate of the data packets sent by the additional UE, and
delaying non-critical data transfer by the additional UE.

6. The user equipment of claim 5, wherein the decreasing of the application data rate of the data packets comprises modifying usage of an application used by the additional UE.

7. The user equipment of claim 5, wherein the decreasing of the application data rate of the data packets sent by the additional UE comprises reducing a data rate.

8. The user equipment of claim 5, wherein the decreasing of the application data rate of the data packets from the additional UE comprises using an artificial intelligence (AI) machine learning (ML) model to decrease the application data rate based on historical congestion information shared by the UE.

9. The user equipment of claim 1, wherein mitigation of the wireless network congestion by the additional UE comprises selecting another possible network path.

10. The user equipment of claim 1, wherein mitigation of the wireless network congestion by the additional UE improves performance of the additional UE.

11. A method comprising:
communicating data packets between a wireless network, a first user equipment (UE), and a second UE, wherein the first UE is low latency, low loss, scalable throughput (L4S) enabled and the second UE is not L4S enabled; and
sending, by the wireless network, a first notification of wireless network congestion of the wireless network to the first UE that is L4S enabled,
wherein the first notification triggers the first UE to send a second notification of network congestion to the second UE that is not L4S enabled, and
wherein the second notification causes the second UE to mitigate the wireless network congestion.

12. The method of claim 11, wherein a mechanism for notifying the second UE of the wireless network congestion by the first UE is one or more of the following: radio access network (RAN), Bluetooth and Wi-Fi.

13. The method of claim 11, wherein mitigation of the wireless network congestion by the second UE comprises one or more of the following:
decreasing application data rate of the data packets sent by the second UE, and
delaying non-critical data transfer by the second UE.

14. The method of claim 13, wherein the decreasing of the application data rate of the data packets comprises modifying usage of an application used by the second UE.

15. The method of claim 13, wherein the decreasing of the application data rate of the data packets sent by second UE comprises reducing a data rate.

16. The method of claim 13, wherein the decreasing of the application data rate of the data packets from the second UE comprises using an artificial intelligence (AI) machine learning (ML) model to decrease the application data rate based on historical congestion information shared by the first UE.

17. The method of claim 11, wherein mitigation of the wireless network congestion by the second UE comprises selecting another possible network path.

18. The method of claim 11, wherein mitigation of the wireless network congestion by the second UE improves performance of the second UE.

19. A non-transitory computer-readable medium storing instructions of a user equipment (UE) that when executed by a processor cause the processor to perform operations comprising:
communicate data packets between the UE and a wireless network that further communicates with an additional UE, wherein the additional UE is low latency, low loss, scalable throughput (L4S) enabled and the UE is not L4S enabled; and
receive, by the UE that is not L4S enabled, a notification of wireless network congestion for the wireless network that causes the UE to mitigate the wireless network congestion,
wherein the notification is sent to the UE by the additional UE that is L4S enabled in response to the additional UE receiving an additional notification from the wireless network of the wireless network congestion.

20. The non-transitory computer-readable medium of claim 19, wherein the mitigation of the wireless network congestion by the UE comprises one or more of the following:
decreasing application data rate of the data packets sent by the UE, and
delaying non-critical data transfer by the UE.
